(19) United States
(12) Patent Application Publication
(10) Pub. No.: US 2013/0211963 A1
(43) Pub. Date: Aug. 15, 2013

(54) Facilitation of interaction between providers, buyers, and agents

(71) Applicants: Joseph Williams, Austin, TX (US); William Gaul, Austin, TX (US)

(72) Inventors: Joseph Williams, Austin, TX (US); William Gaul, Austin, TX (US)

(21) Appl. No.: 13/815,781

(22) Filed: Mar. 15, 2013

Related U.S. Application Data
(63) Continuation-in-part of application No. 12/927,532, filed on Nov. 17, 2010.
(60) Provisional application No. 61/281,904, filed on Nov. 24, 2009.

(51) Int. Cl. G06Q 30/06

(52) U.S. Cl. CPC G06Q 30/0617
USPC 705/26.43

(57) ABSTRACT

Systems and methods for sellers of goods and services for providing information relating to existence and features of what they provide, to buyers using a system as herein described that enables a buyer to identify and obtain collections of information that comprise a subset of the contents of a database having multiple records provided by a plurality of sellers. A seller may use a conventional home or office computer including without limitation PC's and MACINTOSH™ computers, tablets and smartphones to transmit information to a system as provided, which is accessible to users also via a conventional home or office computer. A user specifies desired criteria and the system provides the user a subset of information upon which further decisions by the user can be made. In some embodiments, systems and methods provided relate to information concerning the inventory of new home construction in a selected region, which region may include a general metropolitan area.

### CROSS REFERENCES TO RELATED APPLICATIONS

This application claims the benefit of U.S. patent application Ser. No. 12/927,532 filed Nov. 17, 2010 and to U.S. Patent Application 61/281,904 filed Nov. 29, 2009, the contents of both of which are herein incorporated by reference.

### TECHNICAL FIELD

In one general aspect the present invention concerns business relationships between a provider of a product or service, such as a home builder or employer, a buyer of such product or service, including jobseekers, and an agent acting as intermediary on behalf of a provider or buyer, such as a licensed real estate agent or job recruiter, or simultaneously on behalf of both a provider or buyer. In some aspects the invention involves the use of a computer-implemented communications system and associated methods for transferring and exchanging information concerning products and services, such as real properties, between a provider, a buyer, and an agent, which products, services, or properties are available for purchase at present or a future time.

More particularly, in some aspects the invention concerns systems and methods by which a provider of a product or service may communicate information relating to one or a plurality of products and/or services to a database, which database is searchable by a plurality of users at locations remote from the database via a search engine and network connection.

### BACKGROUND OF THE INVENTION

Ever since the advent of the exchange of services and goods such as real property between buyers and providers, communication to a suitable buyer informing the buyer of the property's availability has been essential prior to the possibility of a conveyance of interest or ownership. Towards assisting providers of real property in effecting sales, various schemes and systems for communication have been devised, including the use of magazine and newspaper advertisements, lists compiled of available properties which are periodically updated, and databases accessible from computer networks which contain descriptions of real property that is available for purchase being offered for sale to the market by a provider or their agent. Throughout this specification the term “provider” includes manufacturers, sellers, and any other person who provides goods or services to any market or market segment.

While many means of communication between a seller and potential buyers have been employed in relation to various goods, products, services, or opportunities, there remains in many industries a level of distrust between agents and providers of goods, services, and opportunities when a referral of a potential buyer is made to an agent, as the agent often has no means for protecting their interests in ensuring that they're compensated for effort, time and resources expended in attempting to match a buyer to particular goods, products, services, or opportunities. It is often the case that an agent toils laboriously towards ushering a sale between a buyer and provider, and the buyer ends up ultimately being serviced by an agent different than the original agent at the time of sale, translating to a loss for the initial agent in view of effort expended. Further, in prior art market circumstances, conflicts of interest can potentially arise for cases in which a potential buyer that was introduced by an agent to a specific property later independently approaches the home builder or property owner directly, without a pre-registration of that potential buyer with an agent.

It is not uncommon for many different agents to desire to represent the same potential buyer in a transaction involving a provider of goods, products, services, or opportunities, in their competition to be compensated for their time and resource investments towards identifying and qualifying the potential buyer, and matching them with a product that suits their needs. At the same time, a provider of the goods, products, services, or opportunities does not wish to be exposed to liability for paying multiple commissions for plural identifications of the same potential buyer by different agents.

Thus, while agents are always appreciative of leads identifying new potential buyers, it does not benefit an agent if that lead is already working with another agent and has already been presented to the same particular provider. Identifying and communicating when agents are already engaged with a particular potential buyer enables the agent to avoid unnecessary resource expenditure, freeing them up to pursue other potential buyers.

A system and method according to some embodiments of the invention provides a framework for identifying new potential buyer leads appropriate to specific products, and protection for agents' interests and resource expenditures, avoidance of duplicity of efforts, confidentiality, and registering such potential buyers as being represented by a specific agent to the providers of the service.

### SUMMARY OF THE INVENTION

The present invention includes methods for facilitating a relationship between a provider, a buyer, and an agent. Methods according to some embodiments of the disclosure employ a system comprising a database containing a plurality of computer-readable records relating to real estate properties that are available for purchase, stored in computer-readable memory (system memory), wherein the records each contain a plurality of search engine query-searchable fields relating to features of a real estate property. There is a communication port suitable for transmitting and receiving data and instructions in the form of electrical signals, to and from remote computers. A database manager is provided for creating user accounts and creating, modifying, and deleting entries present in the database, the database manager being connected to the computer-readable memory responsive to a plurality of said remote computers. There is a database query engine operatively connected to the memory, the search engine or query engine being configured to permit a features-based search of the plurality of computer-readable records by system users. A process controller is operatively connected to at least one of the database manager and the search engine, and the system includes a recorder for logging the activity of each of the users of the system within the system. In some embodiments, the system is programmed to:

A) receive and store system registration information from each person of a buyer, a seller, and an agent in system memory;

B) receive and store descriptive information concerning items of commerce offered for sale by a provider in system memory;

C) provide information concerning items offered for sale by a provider to any member of the general public, including buyers, who access the system;

D) query a buyer who accesses the system to determine whether the buyer desires to be represented by an agent in a future transaction involving a provider's offering;

E) receive a reply from a buyer indicating either identification of an agent already selected by buyer, or a request from buyer that the system assist buyer in their becoming associated with an agent;

F) associate an agent with a buyer;

G) provide an indication to a buyer that an agent has been associated with a buyer in the system;

H) receive and recording an approval from a buyer of representation by an agent;

I) provide notification to an agent that a buyer has accepted representation of the agent;

J) receive and record acceptance of the agent to representation of the buyer;

K) notify the buyer that agent has accepted representation of the buyer;

L) optionally increase the amount of information available to the buyer from the system concerning items offered for sale by the provider to be more than was available to the buyer prior to step (I) above;

M) record the activity of the buyer within the system;

N) optionally provide the recorded viewing activity of the buyer in M) to the agent;

O) record the activity of agents within the system;

P) optionally provide a report of the activity of at least one of the buyer and the agent within the system to the provider;

Q) transmit a request message to the provider, requesting the provider to approve the registration of a buyer with respect to items offered by that particular provider over any selected geographical range, the existence and contents of the request message being recorded and stored in computer-readable memory;

R) transmit an approval message from the provider to either or both of the agent or buyer of the registration of the buyer with respect to items offered by that provider over a selected geographical range, the existence and contents of the approval message being recorded and stored in system memory;

S) Notify a buyer of acceptance by a provider of the buyer and agent's representation thereof.

### BRIEF DESCRIPTION OF THE DRAWINGS

Embodiments of systems provided herein take physical form in certain parts and arrangement of parts, the preferred embodiment of which will be described in detail and illustrated in or with reference to the accompanying drawings which form a part hereof, and wherein:

FIG. 1 is a block diagram exemplifying elements and structure of systems provided in accordance with embodiments of the present disclosure;

FIG. 2 is an illustration of information displayed on the monitor of a computer of a user accessing a system according to an illustrative embodiment of the disclosure;

FIG. 3 depicts a flowchart of activity associated with operation or use of a system according to some embodiments of the invention; and

FIG. 4 is an action matrix illustrating various activities associated with operation and functioning of systems and methods according to some embodiments of the invention.

### DETAILED DESCRIPTION

Throughout this specification reference is made to a buyer, a provider, and an agent. A buyer can be any consumer, whether natural persons or artificial entities including corporations, unincorporated associations, trusts, or any person who is desirous of acquiring an interest in goods or services. A buyer as used herein can also be a job seeker, a celebrity, sports figure, buyer of real property whether developed or otherwise, or an executive. A provider can be any natural person or artificial entity including corporations, partnerships, unincorporated associations, trusts, and includes builders of new real estate construction, and in some embodiments any commodity or item of value, or service(s). A provider as used herein can also be a job search firm that connects prospective job candidates to specific employers while ensuring that the agent (including job recruiters) is recognized and protected for their work. A provider as used herein can also be corporate management, which assigns tasks to selected internal or external personnel, obtaining buy-in and documenting responsibility. An agent can be any natural person or artificial entity including corporations, partnerships, unincorporated associations, trusts, and includes any person acting in a sales agent capacity. An agent as used herein can also be a licensed real estate agent, an executive recruiter, a financial adviser, a sports/entertainment agent or any person or entity acting as an intermediary between two other parties. Goods includes any durable goods which are traded between persons, as well as real property, employment opportunities, and assets of any kind, including financial funds, stocks, bonds, and securities. Services can be any known services performed by one person for another, and include employment services that provide potential job opportunities to potential job candidates as their product. Services also includes finding a new home for a prospective home buyer, finding suitable commercial properties for an investor, allocating assets amongst various financial instruments, matching a sports figure to a team or an actor/actress to an entertainment medium such as a movie, television show, commercial advertisement, play, tour, concert or any other theatrical display.

Current business practices are lacking in that there exists no framework or methodology whereby a provider of goods, products, services, or opportunities can systematically ensure across a broad range of agents from different avenues that the interests of each agent are protected in a real time reporting system. Aspects of some embodiments of the present invention provide systems and methodologies for assigning potential buyers of goods, products, services, or opportunities to a particular agent at a time prior to a sale. This enables the agent to qualify potential buyers based on their credit or any other selected relevant factors, to identify buyers' needs, and locate products having suitable features matching the buyers' needs, while acting on behalf of the potential buyer, provider, or both. The assignment of an agent to a potential buyer via a registration process herein protects the interests of the agent, since the buyer has by their agreement acquiesced from working with a different agent for the same type of specified product identified by the agent when acting on behalf of the potential buyer or provider in matching the buyer to the product selected, in some embodiments for a specified period of time. When the product is real property, methods provided herein effectively reduce market turnover time and add to the value chain at the providers of goods or services end.

While the service of such matching of buyer and agent is valuable to the provider, however, there can be times that a provider may not desire to engage or pay for such service, and methods provided herein enable a provider to decline receiving such services prior to acceptance of such services, precluding agents from expending resources without pecuniary or other remuneration. Thus, a system or method according to aspects of the invention can provide notice to an agent when a provider is not accepting a potential buyer lead or work of that agent, and the agent accordingly then expects no compensation and once aware of this, the agent can devote their resources to other endeavors or to other providers that would welcome such a service.

A system useful as shown and described herein is in some embodiments made accessible via a network, such as a local area network, a wide area network, or via the internet, in order to permit remote users to have on-line access to a properties records database that is searchable through use of a search engine. Management of information relevant to the system is provided by a database manager, and through use of a computer-implemented system, one or more contracts, agreements, pledges, quasi-contracts and the like between any two or more of a provider, a buyer, and an agent concerning the agent's representative capacity can be affected.

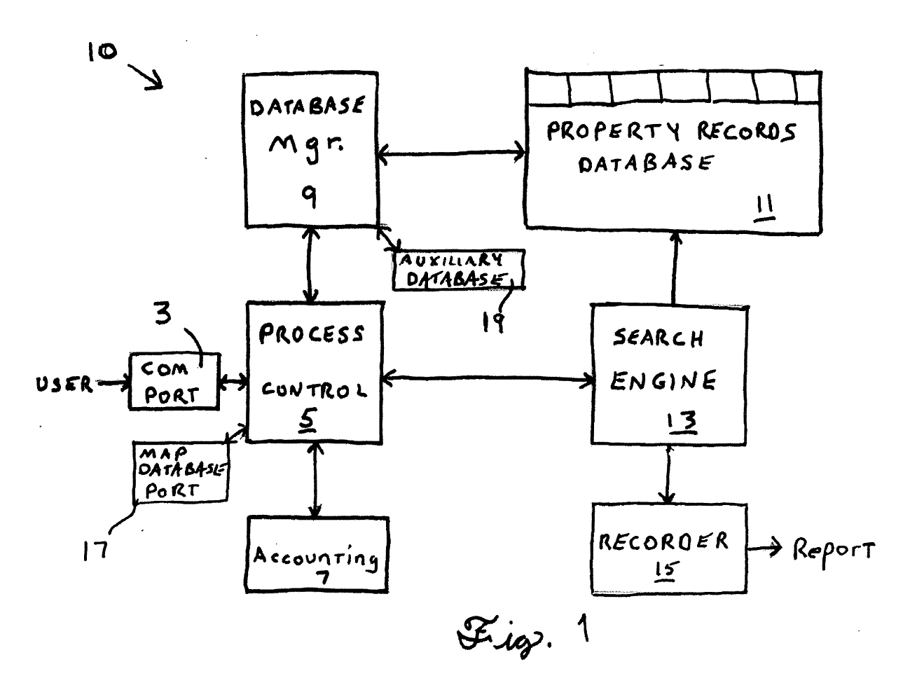

Referring now to the drawings, which are provided for the purpose of illustrating various features of one or more illustrative embodiments of inventions according to the disclosure only, and not for the purpose of limiting the same, FIG. 1 schematically illustrates features of system 10 provided herein, which system may exist in the form of various embodiments as described. A system as provided herein can be implemented using general-purpose computer hardware as a network site. The general-purpose hardware useful in accordance with the present disclosure includes without limitation Unix workstations, WINDOWS™-based workstations, LINUX-based workstations, and other suitable computer systems and operating systems known in the art, as will be readily appreciated by those skilled in the art after reading this specification and the claims appended hereto. In one embodiment, the hardware is configured and customized by various software modules which include communications software of the type conventionally employed for Internet (and in other embodiments other known types of networks, as selected), and a database management system or module. As appreciated by those skilled in the art, a variety of commercially-available database management systems/languages may be employed to implement a system and method according to this disclosure. These include without limitation Oracle RDBMS, SQL Servers, Microsoft Access, and their functional equivalents. Persons of ordinary skill in the art of database management application programming will be able to make and use a system according to the disclosure herein.

The diagram of FIG. 1 includes a process control module 5 operatively connected to other elements of the system as shown that manages the flow of information through system 10. Exemplary process control modules include units recognized in the art as central processing units (CPU's) and their functional equivalents. System 10 includes a communication port 3 which enables access to system 10 through communications with other computers connected to the network, such communications ports being well known in the art. In illustrative embodiments, the network includes access via the Internet to any number of external computer systems, or access through local or wide area networks to other connected computers either directly or indirectly, such as through modems, routers, and other known distribution means, including wireless networks.

Database memory 11, sometimes referred to as memory or system memory herein, is operatively connected to other elements of the system as shown and is provided as an electronic storage medium on which information and records pertaining to real estate properties that are desired to be sold may be stored and maintained, thus providing a property records database. The database memory 11 may be any computer-readable or machine-readable memory known in the art that is compatible with and configured to cooperatively function with the remaining components shown, described, or both. Types of memory used in embodiments of the present invention can be selected from various types of memory which include without limitation: RAM, ROM, PROM, EEPROM, hard disks and any other known machine-readable memory storage device, system, or devices suitable for storing data and information described herein. Database memory 11 thus provides for electronic storage of a properties records database, which database can take the form, as desired or chosen, of a data file that includes a plurality of records, or a plurality of data files that include a plurality of records, with each record corresponding to a single real estate property that is desired to be sold, which is synonymous with being offered for sale, and available for purchase. In an exemplary embodiment, each record in the property records database includes a number of pre-defined fields containing search parameters, these searchable fields being descriptive of information of the type generally presented in relation to real estate listings, advertisements or both. Optionally, any additional information deemed desirable may be caused to be present in a record by configuring the record fields, whether such additional information is chosen to be provided to be present in searchable fields or non-searchable fields in a record. In one embodiment the pre-defined fields are not defined by the owner, agent, or provider of the properties which are being offered for sale. In alternate embodiments, some or all of the pre-defined fields may be defined by the owner, agent, or provider of the properties which are being offered for sale. In an illustrative embodiment, the search parameters include any of the fields selected from the group consisting of: the acreage of the property, the street address of the property, the business use of the property (such as residential, commercial, medical, or retail) the location of the property (defined by any one or more of region, city, or state), the city or unincorporated area in which the property is located, the size of any dwelling(s) on the property, the number of bedrooms present in any dwelling(s) on the property, the number of bathrooms present in any dwelling(s) present on the property, information pertaining to utilities, information pertaining to taxes, pricing information, seller incentives, seller's identity, incentives offered by the seller, school data, HOA data, driving directions, hours available for showings of properties, contact persons, multiple elevations, floor plan configuration option(s), floor plan diagrams, physical map locations of property including satellite and hybrid views, virtual tours, and multiple images of properties, and any and all combinations of any of the foregoing.

The properties records database preferably includes some security or password fields which specify which users may have access to the properties records database for the purposes of generating new records in that database relating to new properties that are to be offered for sale, revising existing records, otherwise maintaining existing records, and deleting records from the property records database.

Generally speaking, a system as herein provided may be accessed by a plurality of different providers of properties for sale, including without limitation a plurality of different new home builders who offer homes of new construction for sale, with “new construction” meaning a new home, dwelling or other structure that has had no occupants or use since completion of its construction. Properties for sale in some embodiments also include existing previously-owned home inventory. In exemplary embodiments, each builder of new homes, or their agent, is able to automatically create through the system from their own remote computer, or in alternate embodiments have created for them by a system administrator, a unique account. As used herein, a remote computer is a computer which is located on premises that is different than the premises at which the property records database is stored in database memory 11. For each unique account, typically corresponding each to a single new home builder, each builder may upload into the property records database a plurality of records for properties which that particular builder is offering for sale, into the properties records database. In addition to new home construction, the property records database may also be caused to contain records having descriptions of features relating to vacant land, sometimes referred to as lots, or condominiums. Features relating to vacant land include all customary features associated with vacant land, including acreage, lot dimensions, ground cover descriptions and other information, or known high density types of developments such as condominium developments or projects. Keyword searchable fields are associated with vacant land or high density projects in a system provided herein, analogously to those provided in relation to new home construction. Thus, in a system according to illustrative embodiments of the disclosure, a builder may list a large number of properties, limited only by their own financial resources, building capabilities, and amount of memory present in the system. A system as provided herein permits a plurality of builders each having a plurality of properties to be offered for sale to upload their properties into the properties records database, which database is thereby caused to contain many listings, potentially into the thousands, and more, depending on the definition of the geographical region intended to be covered by the property records database. Properties may be uploaded to a system as provided herein manually and via computer languages used with networks, such as for example XML.

A system as provided herein also includes a database management module 9 operatively connected to other elements of the system as shown, which database management module manages the creation, revision, and maintenance of records present in the property records database. Suitable such database management modules are well-known in the art and include such database management as Oracle RDBMS, SQL Servers, Microsoft Access and their functional equivalents. There is also a search engine 13 operatively connected to other elements of the system as shown, which search engine may be configured to operate as an iterative search engine, that handles queries made by users to the property records database memory. Search engine 13 may be referred to herein as a database query engine. Suitable search engines capable of searching a database having search fields, searchable fields and the like such as are found in a property records database according to illustrative embodiments herein stored in memory accessible via a network connection may include without limitation the types used by Magellan, Excite, Infoseek, Inktomi, Northern Light, AltaVista, Google, Dogpile, Lycos and Yahoo! and functional equivalents thereof, as search engines are well-known in the art. Other search engines are also suitable, provided they are able to extract a listing of available properties from the property records database in response to a search query by a user, employing search criteria as herein described.

The database management module 9 and search engine 13 may be implemented through commercially-available database management and search engine systems. The property records database may be searched using conventional or known search and query capable software and/or systems.

A user establishing access to the system according to the disclosure though the communication port 3 will be presented with a variety of menus. Communication may be effected through various network-compatible computer languages, including without limitation HTML, XML, SGML, XHTML, and their functional equivalents recognized by those of ordinary skill in the art after reading this disclosure as useful for carrying out the functions herein described.

It is contemplated that users accessing a system according to the disclosure by computer communications will be acting on behalf of either “sellers” or “buyers.” Sellers include builders or providers of new home construction (including newly-constructed houses) or commercial properties and their agents, and buyers include potential buyers of real property—persons in the market to buy a new home, commercial properties, and their agents. An agent acting on their own without any buyer or seller affiliation may also be a user, however users other than system administrators who are not acting on behalf of a seller are typically considered to be acting on behalf of a buyer.

Authorized sellers are those users who are authorized to post (upload) new, maintain, and delete property records relating to real property that they desire to offer for sale into the property records database, to retrieve information relating to which buyers have been viewing real property records present in the property records database, and to view trends/metrics of buyer's behavior based on historical data generated by a system provided hereby. Sellers may be granted “write access” to the properties records database through any suitable or chosen identification or verification protocol, as such are well-known to those skilled in the art. A password system or source terminal identification number may be utilized as a part of such protocol to verify authority for “write access.” In some embodiments an authorized seller may select a properties records database maintenance option at the main menu.

In illustrative embodiments, once an authorized seller elects to access properties records database maintenance, they are presented with options that include inputting a new posting of a property record relating to a property that is to be offered for sale by creating a new property record in the properties records database, accessing a current posting (property already being offered for sale record), and retrieving information pertaining to which buyers have been viewing properties that the seller has listed on the properties records database. When creating a new properties records database record, in exemplary embodiments a seller is presented with a form to be filled out on-line, or the seller may upload an already-prepared property record to the properties records database in some embodiments using XML conforming to a given XSD. When creating a new property record on-line that is to be included in the property records database according to exemplary embodiments, the system may generate prompts that a seller may respond to which enable the seller to fill pre-determined fields for a new property record listing. The seller may enter narrative for a property description, and also information for the search parameters searchable by the search engine. Any search parameter field which has a restriction on available entries may be presented in the form of a menu. If the number of available entries exceeds a predetermined amount, or if otherwise desirable by system administrators, the entries may be presented in a scroll bar window. The entries may be selected by the user, for example, by using a mouse that enables the user to move a cursor and point and click on appropriate entries. In one non-limiting example, the description of a home or any property being offered for sale on the system will be limited to certain predetermined fields, including those such as geographics, price, square footage of a dwelling, number of bedrooms of a dwelling, number of bathrooms of a dwelling, number of garages of a dwelling, number of stories of a building's construction, which building may be a dwelling. A seller posting a property to the properties records database may be required in some embodiments to select parameters of a home being offered only from a predetermined list appearing in a menu. Such methods of indicating information may be made applicable to other searchable fields, and non-searchable fields relating to the seller or a property.

When an authorized seller elects to access their own current property listings, i.e., those properties they are offering for sale by virtue of the property records database containing a record relating to that property that is searchable by search engine 13 and available for viewing by other users, including sellers, a query may be utilized in order to locate an individual or group of their property listing records existent within the properties records database. A system as provided in an illustrative embodiment will verify that the user has “write access” or authority to modify the properties records. The property records present in the property records database may each be presented as a form having fields which is displayed to the seller, and the seller may modify the fields as desired. A seller may also elect to delete any property record, provided they have appropriate authority.

A system as provided according to an illustrative embodiment herein is configured and programmed to store in database memory 11 or other memory such as an auxiliary database (19, FIG. 1) or memory present in recorder 15, associated information that relates to: the identities of users making search queries, the criteria employed by the user in making search queries, the results of search queries made, the date and time of the queries made, and which individual property records in the property records database have been specifically accessed by a buyer. In some embodiments a system according to the disclosure is configured and programmed so that an authorized user may be provided the option to retrieve records relating to the identities of persons who have been conducting search queries for properties present in the property records database using the system. In some embodiments, a system according to the disclosure is programmed sufficiently so that a seller is granted access to some or all search query results generated by users who have accessed the system over any time period selected by the seller. Search query results within this context include information relating to the identity(ies) of buyers who had previously conducted a search query (either by their name or an on-line identifier which may be an email address or any other unique identifier which may optionally be confidential), criteria used by buyers in formulating individual search queries they've conducted using the system, the results of their search queries, and individual property records which the buyer examined more closely than a mere cursory viewing after executing one or more search queries. In other embodiments, a system according to the disclosure is programmed sufficiently so that a seller is granted access to some or all search query results generated by persons who have accessed the system over a limited time span, defined by a system administrator. In another embodiment, a system according to the disclosure is programmed sufficiently so that a seller is granted access only to the searches made by buyers whose search results have caused the buyers to click on a property record posted to the property records database by that particular seller. As a non-limiting example, if there are three providers A, B, and C of new home construction for sale who have posted records relating to the properties they wish to offer for sale into the property records database, and if there are three potential agents D, E, F, and if each of potential agents D, E, F have searched for a new home using a system as provided herein and their search queries have caused them to click on links on their remote computer connected to the system for properties offered by providers A and B, each of providers A and B can log in to the system and generate a report based on information stored in recorder 15 relating to search queries made. When A logs in and generates such a report, the report shows the identity of D, E, and F, and the properties offered by A which have been viewed by D, E, and F. When B logs in and generates such a report, the report shows the identity of D, E, and F, and the properties offered by B which have been viewed by D, E, and F. When C logs in and generates such a report, the report generated by the information stored in recorder 15 (which may be optionally stored in any memory location present in the system) for C does not show that D, E, and F have viewed properties offered by A, B. For each of these embodiments, business intelligence of different character than previously available via the prior art is provided to the providers of the properties. Although the foregoing non-limiting example involved discussion of sellers A, B, C and potential buyers D, E, F, one of ordinary skill appreciates from this disclosure combined with what is generally known in the art that much larger numbers of both sellers and buyers can be accommodated by a system as provided herein, being limited mostly by bandwidth, processor speed, and the amount of memory in the system, each of which can be upgraded to substantially any desired level of performance.

The administrator of a system according to the disclosure has access to all search queries made, their results, date and time, and the identities of those making/having made the search queries as well as the identities of all sellers whose properties are or have been searched. By acquiring and analyzing such data over time, the system administrator is able to generate reports that identify buying trends in real estate markets. Assembly and operation of a system as provided herein in each city, region or other selected area of a country and compiling all datum relating to search queries and purchases is useful for generating nationwide reports concerning buying habits, changes in buyers' preferences over time, the average time a given property is on the market, and other useful information including floor plan preferences, location preferences, and price points and/or ranges.

Thus, in one embodiment recorder 15 is operatively connected to a system according to the disclosure as shown in FIG. 1 and is configured to receive and store inputs comprising information relating to the identity of users who perform search queries, and the particular property records identified and provided to each user performing the searches, and which of the properties present in the search results for each user are actually clicked on by the individual users to enable them to see the entire contents of a property record listing present in property records database 11. Recorder 15 may employ conventional technology, methods, hardware and software associated with logging the activities of online users, as such are known and understood by those skilled in the art. In one embodiment recorder 15, as with database manager 9 and process control module 5, thus includes a microprocessor having at least one input and output. In one embodiment outputs of search engine 13 are inputted to recorder 15, which recorder 15 further includes a database in computer-readable memory into which are caused to be stored by the processor various fields including those relating to the identity of persons making search queries, their search results, the date and time of their search query(ies), and optionally the search criteria used by each person making a search query, and any other information deemed desirable by a system administrator for every search query made of the contents of the property records database over any time frame specified. The activities of those making search queries are thus related to the particular individuals and stored in memory for later retrieval. Reports concerning the activity of users making queries may be directly outputted from recorder 15 to a printer using conventional hardware, and in alternative embodiments recorder 15 is provided with a communication port and report information may be accessed by remote computers connected to the system. In another embodiment, the output from recorder 15 is directed to database manager 9 and is made available to users through communication port 3. In another embodiment, the output from recorder 15 is directed to process control module 5 and is made available to users through communication port 3. In another alternate embodiment, recorder 15 is disposed within process control module 5.

In addition to the features described, a system according to the disclosure also includes mapping capability of properties identified as the result of a search query. In an illustrative embodiment, a system as provided herein upon completing execution of a search query provides an output on the remote-user's computer screen that includes a listing of at least some of the individual properties identified as a result of the search query, and including their street addresses. In one embodiment, a given search query is limited to a selected specific chosen geographical area, one non-limiting example being the greater San Antonio, Tex. geographical area. The geographical region is in some embodiments selectable by the user. In other embodiments, the system administrator determines which geographical area access is granted to various users to the system relates.

In some exemplary embodiments a system of the disclosure and processes associated with its use, the system hereof generates a map of the geographical area under consideration by a user for locating a property for display on the user's computer screen. The map itself is generated using technology and databases known to those skilled in the art, which include without limitation technologies employed by GOGGLE® Maps and MAPQUEST® maps, although other known mapping technologies and systems are suitable for use herein provided they are capable of generating a map that is displayed on a user's computer screen responsive to the results of a search query made by the user, showing the locations on a generated map of properties identified as a result of a search query of the property records database having been made. Once the street addresses resulting from a search query have been generated, the locations of the properties falling within the scope of the user's search criteria are indicated on the map that is displayed on the user's computer screen. In one embodiment, each location of a property identified as falling within the user's search criteria appears as a tiny balloon on the map displayed on the user's computer screen, although the use of any other type of indicator is within the scope of this disclosure. In a further embodiment, the system is configured to automatically or selectively send driving instructions to a user, via their hand-held or other remote communications device such as an IPhone® device, other type of “smart phone” or their interne-enabled GPS device exemplified by a Garmin™ Global Position Sensing communications device, and like devices. In this fashion a buyer or agent can be provided with driving instructions essentially instantly. This is accomplished using techniques and equipment known to those skilled in the art for generating and sending an electronic message containing driving instructions to a property location, responsively to a search query made using a system as provided herein. A user who is not a seller effectively tells the system their location and driving instructions are provided from that location to a property described in records relating to real estate properties in the property records database. Effectively telling the system one's location can include the user specifying their own physical location, as is known to those skilled in the art using techniques and equipment associated with such systems as GoogleMaps™, Mapquest™ and like systems.

The map database employed in some embodiments is external to a system according to this disclosure and is made available to the system through a map database port 17 operatively connected to process control module 5. In other embodiments, a map database is resident within a system according to the disclosure, operatively connected to process control module 5 sufficiently to provide output to a remote user's computer screen of the map locations of properties identified by a search query of the system by a user.

FIG. 1 also shows auxiliary database 19 operatively connected to database manager 9. Auxiliary database 19 comprises computer memory and is useful in some embodiments as a location at which is stored, in an computer-readable format, information pertaining to sellers of properties for which records have been or are to be entered into property records database 11, and information pertaining to buyers registered or who have an account with the system. That is, in some embodiments an auxiliary database 19 contains information relating to sellers and buyers of real estate. According to operation of a system according in one embodiment, each buyer is required to establish an account with the system prior to gaining access for making search queries, and enter their personal information including name, email address and optionally any other information deemed desirable by a system administrator, including pre-qualification status for buyers and the identity of any agent they may be working with. In some illustrative embodiments, sellers are also required to establish an account with the system and their account information may also be stored in the auxiliary database. In an alternate embodiment, the auxiliary database can itself be embedded within memory 11.

In some exemplary embodiments of a system and its use provided herein, access to making search queries of the property records database is restricted to those possessing a license, permit, or any other selected verifiable information within a political jurisdiction. In some embodiments, the license is a real estate license and the political jurisdiction is a state within the United States of America. Thus, a system as provided herein in some embodiments restricts access to making search queries of the property records database to persons having an up-to-date real estate license. Implementation of this feature is achieved using the same or analogous technology that is known in the art that employed by the Texas Department of Public Safety at www.txdps.state.ts.us for internet-based verification of the existence of a license to drive, whereby persons are given online ability, for example, to request a verified copy of their type #3A driving record. Such means of verifying a current license, government-issued permit, or any other verifiable information, etc., possessed by a user can also include other systems of verification known in the art employed by merchants in their accepting credit cards of buyers operating on line, including verification methods/criteria used by the PAYPAL® service as a non-limiting example. Another example of verification is that used by the United States Veterans Administration wherein a person's social security number is used in conjunction with personal information. Verification typically includes the system's accessing a database containing records of license holders for comparative purposes with credentials and/or information provided by a user of the system. The database used may be external to the system herein, as described in reference to a maps database, or in alternative embodiments the database used may be resident in the system. In some embodiments, for cases in which a system as provided herein does not receive verification of a person attempting to use the system as having a valid real estate license, access to the property records database is denied to that person.

A system according to illustrative embodiments of the disclosure also contains, additional to other elements present in cooperative connection, an accounting module 7 which keeps a tally on the number of times a record for a property listed by a seller is clicked on or accessed by a buyer using the system. The accounting module uses conventional counter technology known to those skilled in the art and associates counts registered with the identity of a record in the property records database. If a builder of new housing construction opens an account on the system and lists only one new home for sale on the system (a single record in the properties records database), and if the record for that particular property is clicked on or accessed by a potential buyer or their agent through the system, say 57 times over the course of one month or any other billing cycle interval defined and employed by the system's administrator, then according to one embodiment the builder providing the property will be sent an invoice or their account charged in an amount that is based on the number of times a record concerning his property was clicked or viewed. Accordingly, in some embodiments if a single builder lists a plurality of properties, the system will count how many times each of that single builder's listed properties are clicked or accessed over a billing cycle interval, provide a sum of the total number of accesses made and invoice or charge the builder's account an amount based on the total accesses of the builder's properties. A system provided herein enables a real estate agent to carry out a variety of actions, each of which alone or combined with other actions offers different advantages to a builder/seller, and in some embodiments a different cost structure is applied to each action the agent performs using the system. For example, in one embodiment when a user clicks on a particular balloon on the map, a bubble is opened that includes data relating to the property that might be enough to convince the agent they want to see more detail, or avoid the property altogether. In one embodiment the cost for clicking the balloon is 25 cents. If the agent decides they want to view a complete detail page either from a link caused to be present by the system in the bubble or directly from the search results list, the cost in one embodiment is one dollar, based on transfer of a greater amount of data than associated with clicking the balloon. For instances in which the agent feels that the property is a good fit for a client they have in mind, the agent can either email it or print it out with their own contact data to give to their client. The cost to do so to the builder/seller is three dollars in some embodiments. When that action is complete, the system also provides the builder with contact information for the agent and the buyer if the agent has pre-registered their buyer information. In most instances, such would represent an indication that the agent intends to bring that buyer directly to the property under consideration. For this and some other embodiments, the system is configured to prevent charging the account of the same agent for second and subsequent clicks on a property record that that same agent has already viewed in the past using the system. This is accomplished easily using techniques and equipment known to those skilled in the art to provide a logic circuit that detects whether a particular agent who has clicked on a hyperlink, has clicked on that same property record description in the past. For cases when they have not, a charge is electronically tallied and for cases when they have, no charge is tallied. In some embodiments the seller is billed at a flat rate up to a maximum number of access counts registered in accounting module 7, and a per-click rate beyond that maximum. In another embodiment, a seller pays a pre-determined flat fee and there is no restriction made on the number of clicks or accesses to that seller's properties by buyers during a billing period or any other time interval selected by the system's administrator. Thus, a system as provided can accommodate and offer multiple different payment plans for sellers, including without limitation, pay per click plans, flat-rate plans, and combinations thereof.

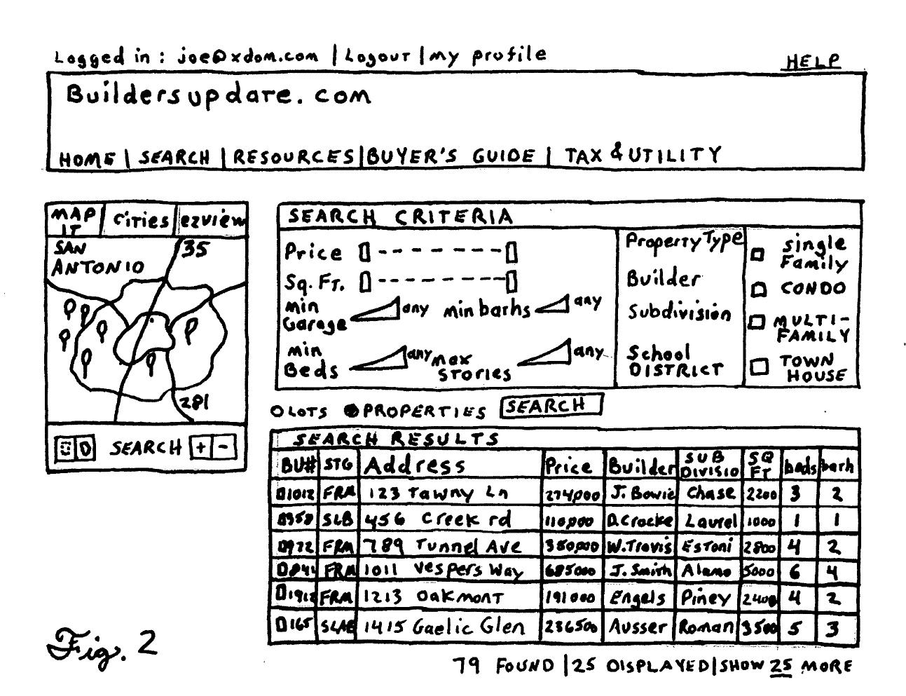

FIG. 2 is an illustration of how the output of a system as provided herein appears on the screen of a computer of a remote user of the system in some illustrative embodiments, a system according to the disclosure providing various screen-outputs dependent on the clicking of hyperlinks present on the “pages” the system provides to appear on the user's computer screen or monitor. Towards the top of this screen is an indicator of the identity of the user who is logged on to the system, followed by optionally-clickable hyperlinks enabling the user to logoff the system or access their personal profile page. When clicked, the personal profile page link leads the user to a system page at which they can view their personal and identification information typical of personal profile pages, including their identity, location, office affiliation, photographs, credit card information and a signature file. In illustrative embodiments a system provided herein in general causes pages to appear on the user's computer screen or display in similar fashion as many internet website's pages appear. There is also a page header, including the site name and various and sundry options listed in hyperlink form including: a hyperlink to the home page location, a hyperlink that leads to the search query page location, a hyperlink leading to resources useful in connection with real estate transactions such as loan calculators and other useful information relating to assisting buyers settle into a new home, a hyperlink leading to the site's buyer's guide page that provides information to buyers concerning the real estate transaction process and optionally legal considerations, and a hyperlink leading to the site's page which is concerned with issues relating to real estate taxes and utilities. Other hyperlinks may also be present leading to other pages on the site which contain beneficial information as deemed by the system's administrator. Files containing remote computer readable web pages, images and other referenced features may be stored in any location indicated herein as having computer-readable memory.

In some embodiments there is a search criteria section provided in web page format by the system that is accessible by authorized users on remote computers, as shown in FIG. 2. The search criteria section is the location at which a user of the system specifies their desired search criteria to be used in making a database query of the property records database 11.

One of the criteria upon which a search query of the properties records database may be based is the price information of properties present therein, and according to illustrative embodiments of the invention it is possible to specify a range of prices in the search criteria section by adjusting the locations of two bars presented thereon, a left-side bar defining the lower end of the desired pricing range and a right-side bar defining the upper end of the desired pricing range, the two bars being slidable on the screen by holding one's cursor over a given bar, pressing a mouse button while doing so and sliding the bar to its desired position, with a digital output visibly denominated in currency units being displayed adjacent to the slidable bars or at some other conspicuous location showing the lower end and upper end of the price range currently selected for the database query about to be made. However, other functionally-equivalent and known means for specifying a range of a searchable field for a search engine to execute during a search query of a database known to those skilled in the art may be employed for selecting a price range, and any other ranges described herein or known to be applicable in reference to describing real property, including the use of drop-down windows, fill-in fields, text fields, and radio buttons may be employed.

Another criteria upon which a search query of the properties records database may be based is the living space associated with each of the properties, denominated in square feet. In some embodiments of the invention there are slidable bars and an adjacent digital readout relating to user-selectable range parameters concerning the square footage of a dwelling on a property as an additional search query criteria, just as was present for the search query price range definition. In some embodiments, in addition to slidable bars, the system is programmed to permit a user to input digital data when specifying square footage or any other selected parameter relating to the items/services being offered by a provider.

Another criteria upon which a search query of the properties records database may be based is the amount of garage space associated with each of the properties. On the search page of a screen of a remote computer connected to a system according to some embodiments of the disclosure there is provided capability for selecting a desirable amount of garage space, which may include a slidable bar that is moveable by the user by hovering their cursor over the bar, holding down a mouse button, and dragging the slidable bar to a location that causes the desired amount of garage space to be displayed in digital form adjacent to the bar or at some other conspicuous location. However, other functionally-equivalent ways to specify an individual value, minimum value, or maximum value of a parameter of a searchable field for a search engine to execute during a search query of a database known to those skilled in the art may be employed for selecting a garage space amount, and any other individual values described herein or known to be applicable in reference to describing real property, including the use of drop-down windows, fill-in fields, text fields, and radio buttons may be employed.

Another criteria upon which a search query of the properties records database may be based is the number of bedrooms in dwellings associated with each of the properties. On the search page of a screen of a remote computer connected to a system according to some embodiments of the disclosure there is provided capability for selecting a desirable number of bedrooms, which may include a slidable bar that is moveable by the user by hovering their cursor over the bar, holding down a mouse button, and dragging the slidable bar to a location that causes the desired number of bedrooms to be displayed in digital form.

Another criteria upon which a search query of the properties records database may be based is the number of bathrooms in dwellings associated with each of the properties. On the search page of a screen of a remote computer connected to a system according to some embodiments of this disclosure there is provided capability for selecting a desirable number of bathrooms, which may include a slidable bar that is moveable by the user by hovering their cursor over the bar, holding down a mouse button, and dragging the slidable bar to a location that causes the desired number of bathrooms to be displayed in digital form.

Another criteria upon which a search query of the properties records database may be based is the number of floors or stories associated with each of the properties. On the search page of a screen of a remote computer connected to a system according to some embodiments of the disclosure there is provided capability for selecting a desirable number of floors or stories, which may include a slidable bar that is moveable by the user by hovering their cursor over the bar, holding down a mouse button, and dragging the slidable bar to a location that causes the desired number of floors or stories to be displayed in digital form.

The aforesaid search criteria of price, square footage of a dwelling, garage space, number of bathrooms, number of bedrooms, and number of floors or stories are those for which fields exist within the property records database associated with each property present therein, in illustrative embodiments of the disclosure. However, other fields and hence search criteria may be created by the systems' administrator. In some embodiments, the search of the property records database will be cumulative, that is, in a single search query all of the foregoing features will be searched for simultaneously by the search engine in a single search, and the results generated will feature properties having all of the characteristics specified by the user. At the option of the user, any one or more of these criteria may be effectively omitted, such as by in the case of desiring to see properties of all price, one adjusts the lower range to $1 and the upper range to a very high dollar amount, or in the case of desiring to see all homes with garages, the minimum amount of garage space may be set to an option specifying “any number” of garages. A system according to some embodiments of the disclosure includes accommodation of search queries based on further searchable fields such as the property type, which may without limitation, be based on such fields as the name of the builder, a particular geographical area or subdivision, and school district. Selection of one of these property types is in some embodiments made by checking a box or alternately highlighting a button on the search screen prior to executing a search query. Moreover, additional potential search fields can include the type of dwelling, be it a single family home, condominium, multi-family dwelling, town house, etc., which selection can be made by checking a box or alternately highlighting a button on the search screen prior to executing a search query. Thus, by one non-limiting example, a person seeking a new home to purchase may register to gain access to the system and upon gaining access navigate their browser to the search page. The user then specifies a price range of between $150,000 and $175,000, a square foot range of 1000 to 1500 square feet, a minimum of one car garage, a minimum of three bedrooms, a minimum of two bathrooms, a single floor layout ranch style dwelling that is a single family home, built by a particular selected builder. Once these parameters have been specified, the user then clicks on the search button, which executes a search query causing the search engine to use the specified criteria in locating all records in the property records database meeting the criteria specified, and the results are quickly displayed in a Search Results table, whose format in one embodiment is shown in FIG. 2, although the results listed therein are not a result of this particular search but are provided only as exemplary. In some embodiments, the search criteria are cumulative, that is, all specified criteria are taken into account by the search engine when making a query of the property records database. Various features of a system described herein may be functionalized by providing radio buttons to the view of a network-viewable page, such as in the search criteria section shown in FIG. 2. In one embodiment, two clickable radio buttons are provided, with one radio button representing a default setting (such as “properties”) and the remaining radio button representing a clickable option, such as “available lots”. Other embodiments employ 3 radio buttons, for: vacant lots, condominiums, and developed properties. In some embodiments for developed properties, the system is programmed to include a drop-down menu on a screen or web page viewable by a user which describes the status of various types of properties, including “ready to move in”, “completed”, and “yet to be built.” In one embodiment upon initial presentation to a viewer, the system is defaulted to providing a page view that permits entry of search query criteria that will be used in querying among properties featuring new home construction only, not including available lots. By clicking on the “available lots” radio button, the system limits records searched in a query as only relating only to vacant land. In another embodiment, a plurality of radio buttons are present relating to the language used on a viewable page provided by the system to a user. In one embodiment, two radio buttons are present, one being English and the other being Spanish, and by clicking on one or the other the user selects the language desired. Such a feature is implemented using known language translation software operatively linked to the system. Thus, as used herein, real estate properties includes both available lots having no construction on them, and land containing a dwelling that is new home construction.

A map is caused to be displayed on the screen by the system as shown in FIG. 2, and at the same time, approximately the same time or shortly thereafter in various embodiments, the Search Results table is generated, the locations of each property identified by the search query are plotted on the map, in the form of markers which in one embodiment appear as tiny balloon-like markings, as shown. The map sub-section is preferably provided with tools typically used with computer-based mapping systems, including a zoom feature.

In some embodiments the Search Results displays the various search criteria for each property, including price, identity of the builder for new construction, the subdivision, square footage, number of bedrooms, number of baths, and further provides the street address location of the properties to the user. In some embodiments, the first column of the Search Results table includes the BU number, which is an internal code used by the system as a unique identifier for each property within the property records database. One user option is the presence of a checkbox adjacent to the BU number or alternately any location adjacent to a listing, which when checked by the user clicking with their mouse, re-locates the property so selected to a separate table. In one non-limiting example, a user may find that three properties out of all presented in a Search Results table are most appealing, and may easily re-locate these properties to another table for hard-copy printing or later viewing by saving selected entries among the results to memory. Subsequently, the buyer may choose to personally visit properties identified by a search query, and the provider of the property and buyer may consummate a sale.

Additional features present on the search screen page exemplified by that of FIG. 2 can optionally include a listing at the bottom indicating the number of properties found by a given search query of the property records database, the number of properties displayed, and a highlighted hyperlink enabling a user to access additional search results not shown on the immediate screen view by clicking on the hyperlink.

As mentioned, when accessing the system a user is presented with an options menu. The options menu includes the options of searching the property records database in addition to the option of creating a new property record or modifying an already-existing record in the property records database. When a seller selects the option of creating a new record to be posted in the property records database, the process control module 5 submits commands to the database management module 9, which in turn passes information for the fields of the specified base from the user's computer through the communication port into the selected database record. In one embodiment, the fields in a property record in the property records database are populated through use of a form presented to the seller, which may optionally include a field for a user password and a field that is used to designate the record as a submission to the property records database. The seller may be presented with an option of maintaining the record in the property records database without its being accessible or locatable by search queries conducted by other users, or to make the record active and subject to identification by search queries of one or more buyers. A system according to the disclosure is not necessarily limited to any exact physical file, record and field structures described herein, as other structures that are functionally equivalent from a logical standpoint are equivalent for providing a system having the functionality provided by this disclosure as those skilled in this art immediately recognize.

In some embodiments of a system according to the disclosure, a DELL PowerEdge® 2850 WIN2K3 server computer available from DELL CORPORATION of Austin, Tex. is employed as a source of the various components of the system 10 of FIG. 1, is connected to the internet or any other selected network, and buyers and sellers may each use their own personal computers disposed at remote locations from the server computer, in implementing methods according to the disclosure that use the system, the computers disposed at remote locations being connected to the server computer in one embodiment via an internet connection.

The search engine 13 is invoked in some embodiments when a buyer selects the properties records database option from a menu, which may be the opening (initial) menu presented to a user at a remote computer by a system of this disclosure. In some embodiments, when the search engine is invoked to search the property records database, a number of scroll bar type menus is presented to the user. The scroll bar menus can correspond in different selected embodiments to some or all of the various search parameters and fields associated with or relating to a property record in the property records database. The menu presents predetermined options corresponding to the available entries for the various fields. The user then selects query entries from the options presented. In an alternate embodiment, fields which are not limited to predetermined entries may be queried using a key word or literal string inquiry, such as for a swimming pool, guest house, barn or other features associated with real property, in addition to, or in lieu of the fields associated with predetermined entries. The search engine returns an indication of the number of property records that satisfy the query parameters, and additional iterations of the search may be executed, for example if too large a number of results are returned, the user may narrow down the search results by selecting additional features or narrowing a selected range, for example by modifying the price range or any other range or parameter. Then, of the records initially identified in the query, after additional parameters have been specified, re-presentation of search query results are provided by the system to the user, such re-presentation typically containing fewer search results (properties identified) than an initial query. Thus, search engine 13 is configured to operate as an iterative search engine when desired.

A system according to this disclosure is accessible online over the internet at the web address http://www.buildersupdate.com. While described and disclosed in relation to the sales of new home construction for the real estate market, a system according to the disclosure can also be used in facilitating transactions between buyers and sellers in other areas of commerce, essentially unlimited, the sellers not being limited to providers of new home construction. The property records database may also be caused to contain searchable records of pre-owned homes. A system as provided herein has applicability to any product or service having features that can be downloaded into a database record concerning that product or service and having searchable fields. This includes without limitation commodities; existing homes; services; brokered services; goods or services sold which include a contract having commissioned sales; commercial real estate properties including vacant land (available lots) and land with dwellings, buildings or other construction; financial securities; commodities; heavy equipment; motorized vehicles; sea-going vessels; medical/health care; specialty materials; and aircraft.

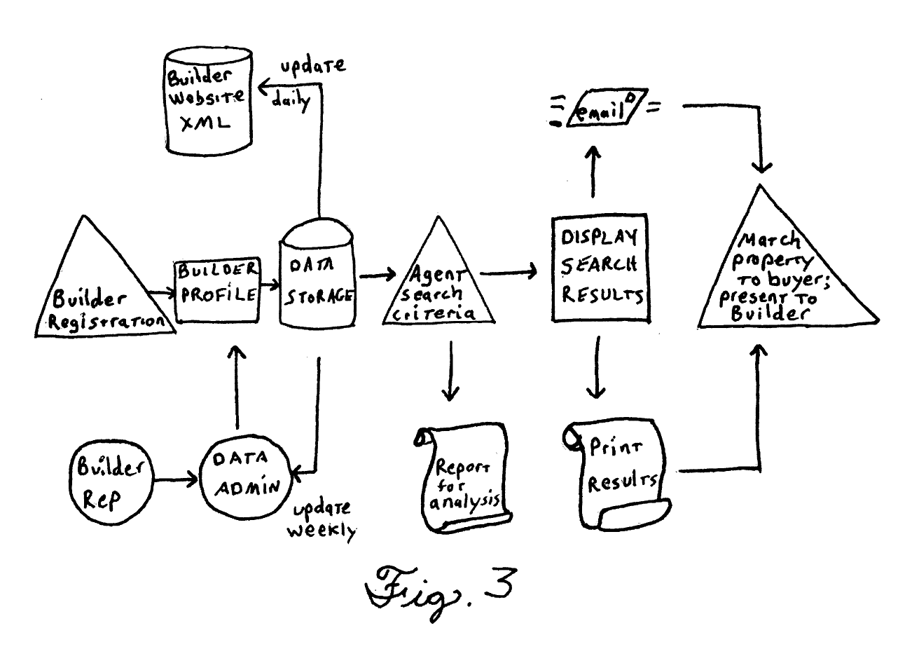

FIG. 3 depicts a flowchart of activity associated with operation or use of a system according to some embodiments of the disclosure. In one embodiment a builder of new homes (seller) registers online with a system according to the disclosure, establishing an account and creating a profile by providing information concerning themselves or their company, the information being stored in a data storage location in the system, which is electronic memory as earlier described. The builder is then given write access to be able to upload records of properties featuring new home construction that they desire to offer for sale into the property records database, denoted in this FIG. 3 as Builder website XML. Builder website XML in this context may comprise the website of the builder that is electronically stored in a system other than that provided by this disclosure through a network connection using appropriate selected known access protocols, or may also be resident in memory of a system as herein provided, in database memory 11 or other memory present. In some embodiments of use of a system as provided herein, the entries in the property records database that are associated with a particular individual builder are updated for accuracy on a daily basis, by the builder themselves or their representative logging into a system such as system 10.

A user may be an Agent who enters search criteria to the system upon which the search engine makes a query that generates search results, which results are stored in a database for analysis at another time. Search results are also displayed on the computer monitor of the Agent user and may be printed in a hard copy report. The Agent user may also provide the search results to a prospective buyer, either by an email communication or by delivering a hard copy report to a prospective buyer, who may make a subsequent offer for presentation to the builder.

In some embodiments, a system as provided herein is operatively connected to an automated telephone call center and configured to execute an automated telephone call (on any chosen periodical basis) to the seller. Upon the telephone's being answered, an automated voice identifies itself as being representative of system 10 and offers a menu of options selectable by the call recipient depressing one or more buttons on their touch-tone keypad or by voice-recognition, with one option being for the recipient to indicate that they would like to update their records, at which point the automated call center switches the recipient over to a living person system administrator who then speaks with the builder and effects the changes.

In some embodiments the records in the property records database of a system herein each include a timestamp/datestamp on the record, that is displayed to a viewer, which is typically a buyer or agent. Such feature enables the buyer or agent to know how “fresh” the information contained in the record is, that is—when it was last updated by the seller. In some embodiments, the display of search results shown in FIG. 2 prioritizes the listing of property records shown based on how fresh they are. That is, the listings which appear first or topmost in the list of search results are those whose seller's have most-recently updated the information present in those listings. Such a feature is readily effected, by sorting records in the property records database based on the timestamp/datestamp that each record was last updated. Thus in some embodiments, results from a search query are provided and then sorted by their freshness prior to being displayed in the search results window. This feature provides incentive to sellers to always make certain that the records they enter into the system contain the most complete, up-to-the-minute accurate information as reasonably possible, to ensure the highest level of real-time accuracy of the contents of the property records database. Such features are readily implemented in a system provided herein when the system is further provided with a system clock operatively connected to either the database manager or process control module. A time and date field is created and associated with each record present in the property records database and a timestamp/datestamp is entered into the time and date fields for each record in the property records database upon their creation, modification, or in response to a periodic telephone-generated indication that there are no changes. Thus, in some embodiments the system is configured to sort results generated as a result of a particular given search query based not only on features described in property records, but also based on the timestamp/datestamp fields, in chronological order. Sorting, when and as used herein shall be understood as including conventional techniques, algorithms and equipment known in the art as being useful in sorting records stored in computer-readable memory.

For instances when an automatic telephone call is made by the system to a seller seeking an indication of whether the seller has any changes or updates to any of their records in the property records database and the call-recipient seller indicates they have no changes or updates to any of their records, the system is configured to automatically update the timestamp/datestamp for each of that seller's records present in the database to the current time of the phone call. In one embodiment such an automated telephone call is made on a weekly basis, however, any time period may be selected to pass between successive automated calls are made.

A system according to the disclosure is capable of storing thousands and more individual records relating to individual properties of new home construction in database memory 11. When a remote user such as a buyer using a remote computer conducts a search query, results are provided to the user generally in less than 10 seconds from when the user executes the search query. In some embodiments results are provided to the user in fewer than five seconds from when the search is executed. In some embodiments, search query results may include any number of individual property records between about 1 and about 50 records from the property records database, including all numbers and ranges between about 1 and about 50, and including 1 and 50. A system according to this disclosure is typically capable of providing search results including these numbers of property records from a properties records database containing hundreds of entries.

Thus, a system provided herein enables builders having accounts with the system in illustrative embodiments to add their property records to the property records database, modify their records, delete their records, and also have access to knowledge of who has been viewing the records they have posted into the property records database. A system according to the disclosure is advantageous to a builder, in that their marketing costs are substantially lowered through its use, compared to currently-existing marketing methods. Builders are able to gain free time, by eliminating the need to manage their marketing efforts through conventional or prior art methods or systems. Further, builders are able to extract analytics that have never been available to them from prior art methods or systems previously, due to the new function conferred by a system herein. Trends data derived therefrom can be of immense aid in providing an appropriate inventory to anticipate market needs in both current and future times.

Using pre-registration of clients, potential conflicts can be avoided and a mechanism provided whereby email communications made possible by collection of email addresses by the system enables builders to broadcast important information to the entire community of buyers' agents who are registered with the system, or selected segments thereof, the email addresses of the agents being readily retrievable by the database manager and process control module. In one aspect, to protect the initiative of the real estate agent that has introduced a buyer to a prospective seller, a system as provided herein is configured to enable real estate agents to purchase a license for their clients, which license can be an individual license or a bundled package of individual licenses. These licenses enable clients (buyers) designated by the agent access to use the search engine feature of a system provided herein in locating records of properties of particular interest. The searching activity of the agent's clients is monitored and recorded in computer memory present in recorder 15 for later extraction and sorting to enable generation of a report that shows the buyer's searching activities. When appropriate or desired, the real estate agent may subsequently transmit a pre-registration form to a specific builder on behalf of their client, introducing them to the builder with contact information useful in the event the client decides to physically view a property for example on their own initiative and travel. In some embodiments, the pre-registration including the potential buyer/client's information is timestamped/datestamped at the time it is sent from the agent to the builder.

At the time of creation of an account with the system by either a buyer or seller, these users are prompted to enter an email address for themselves as part of the process of becoming registered users. In one embodiment, a system as provided is configured to send emails internally between various registered users. In another embodiment, a system as provided is configured to send emails between various registered users through servers and systems external to the instant system, using such configurations as are known to those skilled in the art. In some embodiments, when a real estate agent sends information via an email communication using the system herein to a registered user who is the agent's client, the builder will have the ability to view the name of the buyer and their contact information, in addition to the real estate agent's contact information. In a further embodiment a system as provided enables a user to contact other users directly using various communication media including without limitation voice-over-internet communications such as those available from www.skype.com, and text-over-internet instant messaging such as those available from MSN, Yahoo!, and Google. The presence of such features is provided using techniques and equipment known to those skilled in the art in providing a clickable link on a network-accessible viewable page provided by the system that opens a SKYPE® window or text-messaging window on a user's computer monitor. In one embodiment, a user enters their own telephone number, and is responsible for communications charges between themselves and other users, charges being made using techniques, methods, and equipment known to those skilled in the art. In one embodiment the user providing the telephone number is a seller.

Thus, a system provided herein provides buyers' agents with an ability to acquire all necessary information upon which decisions regarding purchase of a new home. Data in the system is as up-to-date and accurate as possible, since the builders have the ability to ensure its accuracy directly and quickly, effectively immediately at any given time. Buyers' agent's commissions are protected by the pre-registration process enabled by a system provided herein, and by reviewing search engine queries conducted by clients, agents can remain informed of clients' interests.

Another feature a system as provided herein may include is a custom spec homes feature. This is suited for use in many embodiments and including those for which vacant land is being offered by a seller, who is a builder. The system is configured to receive and store in computer-memory a plurality of home floor plans, layouts, or architectural options offered by a particular given builder. That is, the builder may upload a plurality of possible choices of architecture/plans for buyers to review, and associate such plurality of choices with a plurality of records in the property records database relating to vacant lots. For example, if a builder offers four different new home construction choices and has eight lots of vacant land listed in the property records database, when a buyer or their agent accesses a single vacant lot for review of the features present in its records, an option is indicated to the buyer or agent to select one of the four choices to be associated with the particular lot being viewed. An option is provided to “advance” the choice of new home construction to the next one offered by the builder and by repeatedly advancing the selection, all of the construction offerings of that particular builder applicable to the vacant lot being considered may be seen.

A system according to exemplary embodiments of the inventions provided by this disclosure provides agents for buyers of new home construction and available lots with 24 hour, 7-day access to up-to-date inventory, enabling a new tool for agents to facilitate sales of new home inventory, increasing the velocity of money in the real estate economy. Additionally, it provides any real time data necessary to facilitate all aspects of the search for new homes that buyers might need, above and beyond inventory information. A system according to the disclosure further provides links and quick access to information agents might need to assist their overall business practices. A system as provided herein further provides a means by which agents can identify their buyers to builders to protect their efforts to bring about a sale.

In one non-limiting, exemplary method according to the invention, a tangible collection of information relating to features of real property for sale, which in non-limiting exemplary embodiments exists in the form of printed characters present on paper or other conventionally-recognized storage media (which includes computer-readable storage media), is transformed into electronic signals. This may occur in more than one way, one way being when a builder enters information relating to a property record using their remote computer into the property records database of a system as described herein, employing the various machine elements described herein operating in cooperative fashion with one another. The electronic signals representing a transform of that information (which can include carrier waves, electrical impulses, a series of electrical impulses, binary-coded electromagnetic energy, as are known in the art) are transmitted via a medium which supports propagation and transmittal of electronic signals (which can include conductive wires as a medium, and the earth's atmosphere as a medium in the case when a wireless transmittal system is employed that includes a wireless transmitter and wireless receiver, operatively connected respectively to computers used in a system as described, as such and their implementation are known in the art) and are received by a system according to the disclosure via communication port 3 and subsequently directed to be stored in property records database, in one embodiment located in database memory 11, for storage. In this fashion, a tangible collection of information relating to features of real property for sale is in one embodiment transformed into an electronic format at a builder's remote computer, transmitted to a system according to the disclosure, and caused to be again transformed but this time into a computer-readable or machine-readable format, and stored on a computer-readable medium such as database memory 11 or optionally other memory present in the system. The computer-readable medium itself is tangible in the sense that database memory 11 is typically a physical article comprising memory elements mounted on a support including controlling circuitry, the database memory 11 being capable of being physically removed from a system according to the disclosure, such as for inspection, repair, replacement, copying, physical transportation, or any other desired known and useful purpose relative to computer components. The processes involved in causing the formerly-tangible collection of information to become present in computer-readable or machine-readable format in database memory 11 effects changes in the configuration of the states of a plurality of physical memory elements present in database memory 11, in the case of when binary language is employed, many zero states may become ones states and vice versa as is generally known in the art of computer memory. Subsequently, a remote user such as a buyer may act through their remote computer connected to a system as provided herein, to perform a search query of the database memory 11, and results of such queries generally include a subset of all information present in the formerly-tangible collection of information sent to the system by the builder. The search query results are subsequently transformed into electronic signals and transmitted via a medium as when the builder had sent the formerly-tangible collection of information to the system, transmitted to the remote user's computer, where the electronic signals themselves are once again transformed into a human-readable format, such as the English or other languages, and displayed on a computer monitor (screen), again transformed and stored in memory present in the buyer's computer in a computer-readable format, or caused to be printed on paper, thus providing a tangible collection of information relating to features of real property for sale, which is in some embodiments a subset of that transmitted by the builder or a plurality of builders to the system. In some embodiments, the tangible collection of information relating to features of real property for sale obtained from a search query in the above fashion by a buyer from the system comprises a subset of all of the information present in database memory 11 and includes information relating to features of real property for sale that is provided to the system by a plurality of builders. Thus, this disclosure provides for repeated transformations, from a tangible collection of information containing human-readable characters, to electronic signals, to physical changes in computer memory, and following extraction of a subset of the physical changes to the computer memory, that subset is again transformed to electronic signals which are moved to another location and re-transformed into human-readable characters comprising only a subset of the original tangible collection of information. In various exemplary embodiments, storage in computer-readable medium may be transient, semi-permanent, and permanent.

According to aspects of some embodiments of use of a system and method as described herein, a buyer and an agent electronically execute an agreement with one another that the buyer will not employ services of any other person acting in an agent capacity, with respect to transactions involving products from a particular provider, sometimes in a particular geographical region. Since this is an important undertaking, a system and method according to some embodiments includes a system of check and double check to enable parties entering agreements two opportunities to decline to agree, ensuring all participants are onboard with the official record of representation involving a mutually-contemplated transaction, which may in alternate embodiments be either legally-binding or non-legally-binding on the parties. In some embodiments, all communications in connection with such agreements effectuated transmitted through a system as herein described are recorded, date and time stamped, and maintained in both the agent's and provider's files in the systems' computer-readable memory, for archival purposes. Such overall arrangement ensures that the time, work, and other resources of the agent is protected.

An aspect of some embodiments of the invention involves validation of licenses for persons engaged in businesses where agents are required by either state or federal law to be licensed. Real estate agents are but one example, other licensed agents being able to derive benefit from use of a system or method as provided herein. In some embodiments the system is programmed to insure that only licensed real estate agents are permitted to use the system to receive, work, and present qualified potential buyers to providers, such as providers of new home construction.

A feature of some embodiments of the invention is that agents are able to register their buyers with respect to a specific provider, e.g., a home builder, in a specific geographical region or metro area using a system as herein described to insure that the agent be recognized as the source/procurer of the sales lead to earn a commission.

According to aspects of some embodiments of the invention, systems and methods provided herein afford a mechanism whereby agents can generate subsets comprising a listing of products that have been discriminated from a much larger database, which can include generation of listings of new construction properties of providers based on criteria specified by the buyer or agent. An agent can share the contents of any of such subsets generated with their list of qualified buyer clients with a view towards matching buyers with properties using a system as herein described, via email or any other method. Another aspect of some embodiments of the invention involves creation of a user hierarchy which is a form of customer relationship management tool (CRM). Using the system ensures that the leads identified by agents are presented to the proper individual in a large organization for expedition, and protection for the corporation/organization/provider that the same lead was not provided to another part of the organization and protected. Without this in place, a large organization can sometimes be accountable to pay multiple commissions to different agents for the closure of a single sale.

Another aspect of some embodiments of the invention involves an incentive functionality which displays sales incentives and requirements presented by a provider of items of commerce to prospective agents to motivate them to bring the provider potential buyers who have been previously deemed financially qualified to undertake a contemplated transaction.

Another aspect of some embodiments of the invention involves a home buyer portal, which gathers buyers' system registration information including their identity and contact information. Such information can be processed by the system to collect and sort such information for the purpose of generating prospective buyer leads, which leads are subsequently distributed to agents who are registered with and approved by the system to have access to the system via an agent portal.

Another aspect of some embodiments of the invention involves Help Videos with right click-to assist both agents and providers, to provide help bubbles that will show a short video/tutorial by right clicking on a bubble-shaped or other icon.

Another aspect of some embodiments of the invention involves private label integration, which provides a mechanism whereby individual agents automatically create a portal that leads their clients or potential clients to their own business website using data from a systems of this invention and incentives to create potential sales leads that agents can qualify and work with exclusively to be presented to at least one providers.

Another aspect of some embodiments of the invention involves Facebook™ social network integration to present properties previously identified as to meeting a prospect's needs via social networking methodology provided by Facebook™ social network.

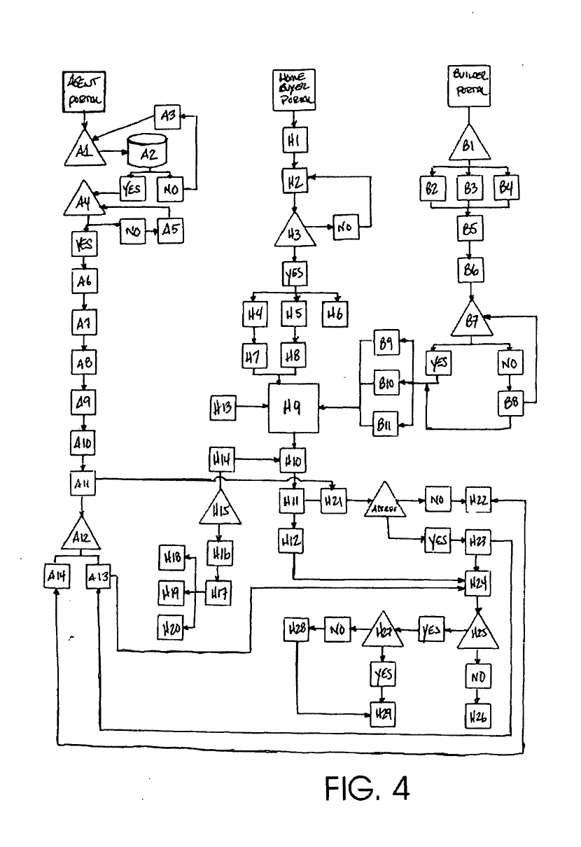

A system as provided according to embodiments of the invention is useful in facilitating occurrences laid out the action matrix shown in FIG. 4, in which are included decision and action points associated with use of a system provided herein by a potential home buyer, a provider of homes, and an agent. Although real estate properties are used as but one illustrative embodiment, the present invention is applicable to and includes any other known commercial activity able to derive a benefit from making use of any particular system and/or method as provided herein for facilitating interactions between a provider, a buyer, and an agent. In FIG. 4 are thus featured three exemplary user portals, and various interactions made therethrough using a system and methodology as provided herein.

### The Potential Buyer Portal

A potential buyer accesses a system as herein provided through its buyer portal via a network connection, and at H1 is able to view product inventory either through a private label interne website of an agent, or through the home buyer portal of a system as provided herein (“the system”). When interfacing with a system as provided herein, a buyer will typically upload various items of system registration information to the system to be stored in system memory, including: their name, postal address, and contact information such as email address and telephone number and any other information deemed appropriate or selected to collect. The buyer is prompted by the system in some embodiments to select a user ID and password associated with access to their account within the system, and the system provides the buyer with: access to the search query engine and the property records database, the vendor database, and the ability to contact their assigned or associated agent.

The potential home buyer is able to generate listings of available properties from the property records database from their remote location, and click on individual properties for more detailed information concerning a particular property at H2, albeit in some embodiments with more limited data than they would otherwise have access to were they to pre-register with an agent via the system. At H3 the system is programmed to present the buyer with the option of associating themselves with an agent having a private label website as created by the system herein, or, to choose an agent from or be assigned an agent by, the system. H4 is the path taken if the buyer is previously represented by an agent, and in such case the system is programmed to prompt the buyer to enter their agent's identifying and contact information. The system is programmed to subsequently create and issue to both the buyer and their agent a set of unique login credentials including a user ID and password. At H7 the home buyer's agent that was indicated as being agent for that homebuyer in H4 is notified by the system that their client is participating in a method via the system. For instances where the agent has not already registered with the system by providing their identity and contact information and agreeing to be bound by the terms of the system, the system queries them with an opportunity to provide such system registration information concerning themselves. For instances where the agent is already so registered with the system, the system is programmed to add the particular potential buyer/client on to an existing list of the agent's clients electronically stored in the system's memory.

H5 is the path taken by a buyer having no agent but who is going to either go through an agent via the agent's private label website, or select an agent through, or be assigned an agent by, the system. In some embodiments, the system is programmed to assign an agent to a buyer accessing the system and requesting same through the buyer's portal, the system is also programmed to subsequently grant such buyer access to a greater amount of information than they would have otherwise had access to, had they elected to not be assigned an agent. The system is thus programmed in some embodiments to automatically assign an agent to a buyer upon the buyer's request sent responsive to an invitation generated by the system, and in such instances the agent is selected by the system from a list of agents already registered with the system. In some embodiments the system is programmed to reward prolific agents by rating the performance of agents according to any selected pre-determined rating system and assigning prolific agents more of such buyers than they would have otherwise received merely by being assigned potential clients on a random basis.

Upon an agent's being assigned to a buyer by the system, the system is further programmed to promptly notify the agent that they have a new client, which notification as with other notifications described herein, can in addition to email, optionally be effected via postal mail, text message, fax, or any other conventional electronic means. The system is programmed to enable the agent to indicate to the system that they accept the new client, in some embodiments responsive to the system's querying the agent. In some embodiments for instances where the agent does not respond within in a previously-agreed time frame to a system-generated query concerning the agent's acceptance of a new potential buyer who has expressed desire to be associated with an agent within a pre-selected time frame, a referral is made by the system to another of its registered agents with the same query for acceptance, until an agent accepts the buyer as a client, repeating the process if necessary. H6 represents buyers who elect to not be represented by an agent.

A system according to some embodiments of the invention is present in FIG. 4 as H9, through which buyers who are represented by an agent after completing a pre-registration herein are able to view all details concerning individual offered items from a complete inventory of items in the systems' database memory. In some embodiments the system is programmed to record the activity of buyers using the system, and provide such record to the agent in order to assist the agent in better understanding what is most desired and important to a buyer.

In some embodiments the system is programmed to generate activity reports of the activity of buyers and agents using the system with reference to or selection of products offered by a particular provider, and in some embodiments such activity reports are only provided to providers who have subscribed to such functional use of the system. Information concerning identity of all agents and their respective brokers is stored in system memory and provided to providers to assist providers in managing their relationship with the market.

In some embodiments, the present invention provides a system that is configured and programmed to determine and recognize the identity of the first agent that has followed pre-selected rules for identification, qualification, and submission of a potential buyer as a client of an agent to the system. Once such a first agent is recognized by the system, typically upon completion of the pre-registration process, a notification is transmitted to other agents who may have attempted or may later attempt to submit that same potential buyer to the system, to inform such other agents that the subject potential buyer has already been presented, acknowledged, and is in a working relationship with a first agent. Such communication precludes agents other than the first agent recognized by the system from expecting compensation for their submission of the same potential buyer as a sales lead to a system as provided herein.

At H10 agents can use the system to conduct searches of property listings stored in database memory to assist their buyers, and the agents' activity within the system is recorded by the system. In some embodiments the system is programmed so that at H11, agents can pre-register buyers assigned to them by the system to a specific provider for a specified geographical region. Buyers who have been pre-registered by their agent with specific builders for a specific geographical region are notified of same by the system, such as at H12.

A feature is present at H13 in some embodiments of the invention for adding clarity to various functionalities of the system is the presence of an icon on various pages displayed by the system on a user's computer screen, which icon can be “right clicked” using the button of a computer mouse not predominantly used for making selections or equivalent device, to activate a video player window that plays short demonstrations of how to use the particular functionality of the system associated with the icon that was right-clicked. Such tutorial demonstrations reduce the learning curve of system use for persons unfamiliar with the system.

Some embodiments of systems and methods of the invention include a social media insertion functionality associated with product listings in the database memory, such as Facebook™ social media insertion functionality at H14. Methods for effecting Facebook™ social media insertion functionality are well-known in the art and a window to Facebook™ social media is in some embodiments integrated into the product selection process while either a buyer or an agent is performing searches of various inventory served up to them by the system in response to a search query. This includes display of information concerning a particular product and association of a “like” button with each page containing a record from the product database, which pages in some embodiments are real estate listings. Such functionality enables a buyer or an agent to click the “like” button that is associated with a particular property at H15. For properties which are “liked”, the system provides at H16 for a thumbnail picture of the particular property that was “liked” to pop up on the user's monitor, featuring text including any chosen amount of descriptive information concerning an offered item, product service, etc. A hyperlink is also provided that links to the website of the system according to the invention to indicate to remote users using social media the source from which the property was located, along with a request for any person viewing the insertion to comment or also “like” the specific property, and also for such persons to conduct their own search queries using the system, for additional properties/items/services. At H17, interne or other network users who are not registered with the system who view a Facebook™ social media insertion from H16 either on a buyer or agent's Facebook™ social media personal or business web page that clicks on the link to see more details are also queried by the system with an opportunity to view additional properties from the property records database. Such person at H18 is typically a new prospect who may be a potential buyer, and is queried by the system with an option to register as a buyer with the system, in order to be afforded the opportunity to have less restricted access to the properties in the property records database. If the new prospect themselves are a licensed real estate agent at H19, such person may themselves register as an agent with the system and gain further access to viewing records from the property records database. If the new prospect themselves are a builder at H20, such person may themselves register as a provider with the system, and gain ability to download their own inventory into the property records database, making it available for query searching and display by others accessing the property records database.

In some embodiments a system as used herein is programmed to afford the provider an opportunity to view the identity of buyers presented by agents during a pre-registration process, and to record and store either the provider's acceptance or declination to accept any given buyer at H21 when presented a request by an agent for the builder to approve pre-registration of a potential buyer. In some embodiments for instances in which a provider declines a buyer during the pre-registration process H22, the agent is notified by the provider of the decision, and the provider provides a reason for the decline or non-acceptance.

For instances where a provider and agent have a disagreement, the system retains time and date stamped records of the submission of the buyer to the provider by the agent, which are available for potential use in resolving questions of propriety should a need so arise. At H23 when the provider accepts a buyer during the pre-registration process, the pre-registration becomes officially complete and the system notifies the agent. In some embodiments, the agent must next accompany the buyer at an in-person meeting with the provider within a prescribed time period in order to complete a full registration of the buyer with the builder at H24. In some embodiments, a physical meeting is omitted, and the buyer, provider, and agent all acquiesce electronically through the system that full registration of the buyer with the provider through the agent is completed. For embodiments in which a physical meeting of the three parties is carried out, in the interim between completion of pre-registration of a potential buyer, the agent is protected in the event the buyer attempts to contact the provider by their own volition, going around the agent.

When applicable, A25 is a decision-making point as to whether or not the agent brought the buyer to the provider within the prescribed time limit as previously agreed to between the provider and agent, or alternately specified by the system. H26 illustrates the instance when the agent did not complete full registration of the buyer with the provider within the prescribed time limit and in some embodiments the system is programmed to inform the parties that for instances wherein a buyer contacts a provider by their own volition or through an agent different from the first agent recognized by the system with respect to that particular potential buyer, that under such circumstance no commission is owed to the agent that completed the initial pre-registration process.

Another uncertainty or decision-making point illustrated in FIG. 4 is at H27 and concerns whether or not the buyer will go through with a sale after an agent successfully completes the registration process within the prescribed time limit. For the instance H28 that the buyer decides not to purchase a particular item such as a home from a provider, but decides to purchase a different product from the same provider they are fully registered with during the time frame that the provider had previously determined and shared with the agent, a method according to some embodiments herein provides for the system to specify that a commission is to be owed to the agent who was responsible for registering the buyer, and optionally regardless of whether the procuring agent assisted on the sale of the other product or property selected by the buyer. H29 represents the desired outcome of a system and method herein, which is the actual sale of a product which in some instances is real estate.

### The Provider Portal

A provider accesses a system as herein provided via a network connection, and first decides at B1 whether or not they wish to utilize the systems and methods as herein provided. For instances where providers desire to use same, the provider is invited to create an account for themselves with the system by entering their pertinent identification information and in return being provided with a user ID and password. When interfacing with a system as provided herein, a provider will typically upload various items of system registration information to the system to be stored in system memory, including: their name, postal address, and contact information, and other information including their position, organization, individual entries or listings of entries of goods, products, items, services, properties of the provider to be offered via the system. The provider and any of the provider's authorized personnel (collectively “the provider”) are prompted by the system to select user ID's and passwords associated with access to their account within the system, and the system provides the provider and its authorized personnel with: the ability to upload information concerning individual or a plurality of goods, products, items, services, properties which it intends to offer, to the system's memory access to the search query engine and the property records database, the identity of agents registered with the system, the identity of potential buyers presented by agents to the provider during pre-registration.

B2, B3, and B4 represent opportunities for the provider to electronically upload a plurality of their offerings to the system via a remote computer attached to a network such as the internet. In some embodiments B2 exemplifies a situation wherein a real estate provider electronically uploads information concerning properties or to-be-built homes using the system's property portal, B3 exemplifies a situation wherein a real estate provider electronically uploads information concerning condominiums using the system's condominium portal, and B4 exemplifies a situation wherein a real estate provider electronically uploads information concerning vacant property lots using the system's property lots portal. In varying systems according to the invention there are varying portals for any elected aspect of a product of a provider, which portals are in some embodiments web pages that lead a user to various other web pages of the system used in administering methods as taught herein.

At B5 a provider sets up various levels of access or permissions that are to be afforded to different persons within the provider's firm or organization, depending on their role. For example, some persons will have the ability to upload information concerning product offerings, whereas other persons are not provided such access for modification of items offered by the provider, but rather have access that enables them to create and/or approve invoices, set up or remove additional users, assign individuals to collect leads generated by the system and create marketing programs to reach agents specific to that builder, region, state, metropolitan area, city, subdivision or property. Each role is defined to have certain privileges in the system, including without limitation view, edit, add/delete, create invoices, pay invoices, accept new sales leads, create and/or approve invoices, set up or remove additional users, assign individuals to collect leads generated by the system and create marketing programs to reach agents specific to that builder, region state, metropolitan area, city, subdivision, or property. In addition, the system is programmed in some embodiments to enable a provider to specify a geographical region desired to be covered by the system for that provider's purposes, such as any one or more of national, regional, statewide, metro-wide, or for individual cities or property levels. At B6 the provider is able to specify sales incentives they may offer, and indicators of such sales incentives are displayed in system database memory records as either national, regional, statewide, metro-wide, specific city or specific individual articles for sale, including individual real estate properties. In some embodiments the system is programmed so that incentives are displayed to an agent viewing a web page of an entry for a particular property listing record in the property records database in system memory, on the web page or descriptive listing relating to that particular entry. In other embodiments all incentives from a particular provider are set forth in more compact form, such as a listing of incentives that can be clicked to review the articles or properties, services, etc. to which they refer. At B7, the system is programmed to permit a provider to make a choice of whether or not they wish to permit or engage in a pre-registration process of potential buyer clients by agents or not.

B8 illustrates the scenario in which a provider has decided to not permit pre-registration of clients by agents with respect to the providers' offerings. Following such choice by the provider, in instances where an agent attempts to pre-register a client, the system is programmed to inform agents that the particular provider is not accepting pre-registrations of clients. In some embodiments the system is programmed to record and store the identities of the agents who attempted to pre-register clients over a selected time period, which in some embodiments is one day but can be any selected time period. The existence of the attempts at pre-registration and the identities of the agents having attempted pre-registration of one or more potential buyers are subsequently communicated to the provider and/or their agents and representatives to inform the provider of the missed opportunities of having such agents pre-registering their clients and showing the clients the properties for sale. Given a high likelihood that the agent might take their buyers to the providers' competitors if their inability to enter a pre-registration process continues, such recordation and communication in some embodiments provides stimulus to providers to change their minds and permit agents to begin a pre-registration process with their clients via the system in reference to that particular provider, representing the feedback loop from B8 back to B7 in FIG. 4.

B9 illustrates the situation in which a provider chooses to electronically upload descriptive information concerning their offerings via their remote computer linked to the system, in some embodiments using an xml feed via a FTP protocol, on a daily or other time basis at the option of the provider. B 10 illustrates the situation according to aspects of some embodiments of the invention in which a provider chooses to electronically update information concerning their offerings or property listings already existing within the system from their previous uploads, via their remote computer linked to the system. In some embodiments this is accomplished through the use of a fill-in-the-blank spreadsheet, which is subsequently converted to XML and transmitted to and processed by the system, thus ensuring information concerning the provider's offerings kept in system memory is up to date accurate. B11 illustrates the situation according to aspects of some embodiments of the invention in which a provider chooses to have the administrator of the system either scrape or manually input data for the provider on some repeating timely basis selected by the provider and the system administrator.

### The Agent Portal

When interfacing with a system as provided herein, an agent will typically upload various items of their system registration information to the system to be stored in system memory, including: their name, position, organization, postal address, and contact information, and other information including the identity of their broker. The agent is prompted by the system to select a user ID and password associated with access to their account within the system, and once registered with the system, the system provides the agent with: a listing of all of the agent's clients, access to the search query engine and the property records database, tracked actions for the clients assigned to the specific agent, and vendor database.

For offerings of providers to which agents are subject to licensing requirements concerning their offerings, such as real estate properties, in some embodiments an agent accesses a system as herein provided via a network connection from a remote computer and is first prompted at A1 to validate that they are in fact licensed. A2 is in some embodiments a database of licensees stored in system memory which the administrator of the system keeps current and up to date. In some embodiments, the licensed person database is located remotely from the system, such as in a government-operated database that is accessible to the general public or the system of the invention under the terms of a contract.

In some embodiments the system is programmed in some embodiments so that in the event an agent who is attempting to validate the fact that they are licensed is denied access to the system, at A3 the system makes automatic contact or communication with the agent to ascertain that all information presented by the agent is accurate, towards eventually validating that such agent is in fact a current license holder concerning sale of the items/services, etc. offered by the provider. In other embodiments, the system notifies the system administrator, who then contacts the agent.

A4 illustrates a point at which some embodiments of the system affords a licensed agent the opportunity to select to have the system create private label functionality for use on the agent's own website. Private label functionality means using a specific URL name determined by the agent, along with a specific branding identification such as a logo, text, icon, or color scheme, combined with the internal workings and user interface of the search engine results in a uniquely branded and exclusively controlled mini-website that an agent can link to from their own website using either a text link such as “Search New Home Inventory” or a graphic display that conjures up the image of new home inventory, or any combination thereof and is accomplished by the system conducting searches, tracking and recording searches done by users of the system, generating and sending emails containing property listings or links thereto to others, registering buyers to sellers, and reviewing vendor databases. In some embodiments, for instances in which the agent chooses not to have the system create a private label such as at A5, the system is programmed to inform an administrative representative of the system, who subsequently contacts the agent to ascertain that the agent is fully appreciative of the various aspects and capabilities of private label functionality. A6 represents a situation in which an agent desires to have a private label site, and enters their data to the system when prompted by the system to do so, such information including name, contact information, site nickname, URL of site linking to, URL of the co-branded site, and icon/logo/or color scheme in order that the system can automatically create private label functionality for the agent by entering this information into a database of the system stored in memory, notifying the technical resources of the demand for the private label and later properly track and record all actions belonging to or conducted through that private label through the system. At A7 the system creates private label functionality for the agent, and at A8 the system transmits a unique hyperlink to the Agent for use on their own website which enables the agent to showcase inventory of items offered by any selected one or more providers directly via the agent's own website.

At A9, inventory is viewed by visitors to the agent's website, and potential buyers are converted into clients by undergoing a pre-registration process with the agent, revealing their identity to the agent, and optionally the time-frame in which the potential buyer (client) desires to take delivery of the items/services offered by the provider. At this stage, once pre-registration has been initiated with the agent, the system is programmed to enable the agent to create unique login credentials for their client, which login credentials enable the client to gain full access to search capabilities of the system's search engine and queries of the property records database or other database of the system deemed desirably accessible to such client by the administrators of the system, the agent, the provider, or any combination of the foregoing in some embodiments. A10 is a point at which the agent becomes available to track the network or interne web browsings of the client through the system, such browsings having been previously recorded and saved by the system for such access by the agent following the client's searches. This enables the agent to understand the desires of the client, and in many instances to assist the client in their search by focusing on entries within the property records database or other database that are consistent with the search habit of the client. The system also provides the feature at A11 for the agent to pre-register their client to a specific provider and optionally for a specific geographical region. A12 illustrates a point according to some embodiments in which the provider is able to either accept or decline the pre-registration of a given client.

The pre-registration process includes the system being programmed to query a buyer who has accessed the system to determine whether the buyer desires to be represented by an agent in a future transaction involving one or more than one items offered by a provider through the system. The potential buyer provides an indication to the system of the existence of an agent having already been selected by the buyer, however the system is also programmed to enable the buyer to request that the system assist the buyer in their becoming associated with an agent. The system then associates an agent with the buyer, either the agent that the buyer had indicated, or one selected by the system, and informs the buyer that the system as associated such agent with the buyer.

At this stage the buyer is queried for their approval of representation by the agent that was associated with the buyer by the system. Upon the buyer providing such approval to the system, the agent is notified that the buyer has accepted representation by that agent. The system is programmed in some embodiments to then query the agent and receiving and recording an acceptance of the agent to represent the buyer. The pre-registration process is then considered to be complete, and the system notifies the buyer that the agent has accepted representation of the buyer.

Thus, “Pre-registration” as used herein means notifying the builder or provider of products/services that an agent has a prospective buyer interested in a specific inventor of that builder and extending enough private information (such as name, address information, contact information, and an estimated time frame in which a purchase is to be made). Once this information is shared with the buyer and accepted, the pre-registration period is closed and the pre-registration of the buyer accepted. In some embodiments a pre-registration process includes entry of a potential buyer's pertinent information including their identity and contact information to the system, and approval by an agent of a request submitted via the system by the potential buyer or an agent proposing an association between the buyer and an agent with respect to items offered by at least one provider via the system, either to the system or to an agent directly.

The system is programmed so that a provider can subsequently accept or decline the pre-registration of the agent and buyer such as at A13. The full registration of a buyer and agent with the provider is subsequently completed either electronically through the system, or at an in-person meeting between the buyer, agent, and provider.

In instances for which pre-registration of a particular client is declined by a provider, the provider can optionally provide a reason for their having declined to the agent, which in some embodiments is through the system. The agent can accept the reason, or alternately discuss with the provider why the client's pre-registration should be accepted. In some embodiments, parties can seek arbitration if desired to iron out differences at A14. In such circumstance, the agent has access to records of the system as proof as to when they submitted the pre-registration of the client to the provider.

A system as shown and described herein is in various embodiments programmed to carry out instructions, make queries, receive responses, provide queries responsive to responses received, and prompt its various users to provide information necessary for undertaking the various methodologies and aspects of embodiments described herein. Programming sufficient for such undertaking include without limitation C, C+, C++, C#, Pascal, BASIC, FORTRAN and other types of programming, with C# being preferred for some embodiments. The nature of such programming in many embodiments utilizes conventional query-response methods known in the art.

In some embodiments, contractual terms are displayed to users of the system, such as during a pre-registration process according to some embodiments of the invention, which can make an agreement conducted according to this disclosure using a system as herein described to be a legally-binding agreement. This is affected in some embodiments by displaying terms and conditions of an agreement and inviting a user of the system to check a box on a web page or otherwise acknowledge electronically that the user accepts the terms and conditions. Such a user can be a provider, a buyer, or an agent or any combination of buyer, seller, and agent. In some embodiments a method according to the invention includes a step of providing an indication to a buyer that an agent has been associated with the buyer, in or by the system, and the system queries a buyer for approval of representation by an agent. At such juncture in some embodiments, prior to approval by the buyer, the system displays legal terms and conditions that become binding on the buyer once the buyer indicates acceptance of the terms, and once the buyer sends an approval to the system of the association with the agent suggested by the system. Similarly, an agent in some embodiments is queried by the system whether the agent wishes to accept to represent a given buyer, and prior to answering such query, the agent is provided with legal terms and conditions that become binding on the agent upon their indication of acceptance of a given buyer as a client. The present disclosure in its various embodiments includes display of legal terms and conditions for any selected circumstance or point in time that a query is made to a user of the system requesting a reply from the user. In some of the embodiments, the system is programmed so that the user being queried by the system is not permitted to reply to a query sent by the system to the user without first indicating acceptance of terms and conditions displayed by the system. Legal terms and conditions are well-known in the legal arts to vary among jurisdictions, and terms and conditions selected by the system administrator as being a requirement presented to a user before a reply is accepted by the system can include any suitable terms and conditions deemed appropriate by the system administrator or their designee.

Various features and aspects of systems and methods provided herein have been described with reference to different embodiments. One of ordinary skill recognizes that some of the features and aspects described may be optional in some embodiments. Systems and methods as provided according to some embodiments herein may or may not include all features and aspects described in reference to different embodiments of the invention, but may be custom tailored to provide a system in a combination that is desired most by its users, which may vary from city to city, region to region, state to state, province by province, among counties, countries, etc dependent on the needs of the market in the region under consideration, or as a matter of personal taste. Some embodiments of the invention can be provided by combining features and aspects described herein with respect to various embodiments with one another, in any desired combination. The present specification thus includes embodiments having features and aspects of different embodiments described herein, as selected by the administrator of the system. Thus a versatility of a system according to this disclosure is that it may be made to comprise wide variety of features and aspects described. Some embodiments do not include verification of a person having a real estate license, while other embodiments do. This versatility in the administration being able to employ different sets of described aspects of a system as provided adds value.

Where components herein specified are indicated as being operatively connected to one another, such connection includes their being in effective electrical communication with one another sufficiently to achieve outcomes herein described. Moreover, included in this disclosure are the combination of the features and/or limitations of any dependent claim, singly or in combination with features and/or limitations of any one or more than one of the other dependent claims, with features and/or limitations of any one or more of the independent claims, with the remaining dependent claims in their original text being read and applied to any independent claims so modified. These combinations also include combination of the features and/or limitations of one or more of the independent claims with features and/or limitations of another of the independent claims to arrive at a modified independent claim, with the remaining dependent claims in their original text or as modified per the foregoing, being read and applied to any independent claim so modified. The present invention has been disclosed and claimed with the intent to cover modifications that achieve substantially the same results as herein taught using substantially the same or similar structures and/or methods based at least in part on this disclosure. Accordingly, one of ordinary skill recognizes that the instant invention is not limited to only the specifically disclosed embodiments, but that it have the full scope permitted by the language of the following claims.

1) A computer-implemented method for facilitating a relationship between a provider, a buyer, and an agent, said method employing a system that is configured and programmed to:
A) receive and storing system registration information from each person of a buyer, a seller, and an agent in system memory;
B) receive and storing descriptive information concerning items of commerce offered for sale by said provider in system memory;
C) provide information concerning items offered for sale by said provider to any member of the general public, including buyers, who access said system;
D) query a buyer who accesses said system to determine whether the buyer desires to be represented by an agent in a future transaction involving a provider's offering;
E) receive a reply from said buyer indicating either identification of an agent already selected by buyer, or a request from buyer that the system assist buyer in their becoming associated with an agent;
F) associate an agent with said buyer;
G) provide an indication to said buyer that an agent has been associated with said buyer in the system;
H) receive and recording an approval from said buyer of representation by said agent;
I) provide notification to said agent that said buyer has accepted representation of said agent;
J) receive and recording acceptance of said agent to representation of said buyer;
K) notify buyer that agent has accepted representation of said buyer;
L) increase the amount of information available to said buyer from the system concerning items offered for sale by said provider to be more than was available to buyer prior to step (I) above;
M) record the activity of said buyer within said system;
N) optionally provide the recorded viewing activity of said buyer in M) to said agent;
O) record the activity of said agent within the system;
P) optionally providing a report of the activity of at least one of said buyer and said agent within said system to said provider;
Q) transmit a request message to said provider, requesting the provider to approve the registration of said buyer with respect to items offered by that particular provider over any selected geographical range, the existence and contents of said request message being recorded and stored in computer-readable memory;
R) transmit an approval message from said provider to either or both of said agent or buyer of said registration of said buyer with respect to items offered by that provider over said selected geographical range, the existence and contents of said approval message being recorded and stored in system memory;
S) Notify said buyer of acceptance by said provider of said buyer and agent's representation thereof.

2) A method according to claim 1 wherein said computer system comprises:
i) a database containing a plurality of computer-readable records relating to real estate properties that are available for purchase, stored in computer-readable memory, wherein said records each contain a plurality of search engine query-searchable fields relating to features of a real estate property;
ii) a communication port suitable for transmitting and receiving data and instructions in the form of electrical signals, to and from remote computers;
iii) a database manager for creating user accounts and creating, modifying, and deleting entries present in said database, said database manager being connected to said computer-readable memory responsive to a plurality of said remote computers;
iv) a database query engine operatively connected to said memory, said engine configured to permit a features-based search of said plurality of computer-readable records by system users;
v) a process controller operatively connected to at least one of said database manager and said search engine; and
vi) a recorder for logging the activity of each of said system users within said system.

3) A method according to claim 1 wherein the agent associated with said buyer at the step of associating an agent with said buyer is one of: an agent indicated by buyer as having already been selected by buyer; an agent selected by buyer from a plurality of agents identified by said system to said buyer; and an agent assigned to buyer by said system.

4) A method according to claim 1 wherein the buyer, agent, and provider physically meet one another at any selected point in time after the pre-registration completed at step L).

5) A method according to claim 1 wherein associating an agent with said buyer within said system is conducted by said agent, said buyer being an already-existing client of said agent.

6) A method according to claim 1 wherein said system provides legal terms and conditions that must be agreed to by said user prior to the system accepting an approval from said buyer of representation by an agent.

7) A method according to claim 1 wherein said system denies access normally afforded to professionally-licensed agents who provide their system registration information to persons not possessing a professional license required for transactions involving the subject items of commerce in the applicable jurisdiction.

8) A method according to claim 1 wherein said providing information concerning items offered for sale by said provider to any member of the general public who access said system is undertaken via a hyperlink present on an agent's own website, which is a link that directs one to a portal of the system.

9) A method according to claim 1, said computer system further performing the step of: U) receiving a request from said agent for system to create a private label website for said agent to be used in conjunction with agent's own website.

10) A method according to claim 9 wherein said system further performs the step of providing a private label website for said agent, responsive to the system's receiving and recording a request from said agent for said system to create such private label website.

11) A method according to claim 1 wherein a notification is transmitted to other agents who may have attempted or may later attempt to submit that same potential buyer to the system, informing such other agents that the subject potential buyer has already been presented and is in a working relationship with a first agent.

12) A method for facilitating a relationship between a provider, a buyer, and an agent, said method being conducted using a system comprising:
i) a database containing a plurality of computer-readable records relating to real estate properties that are available for purchase, stored in computer-readable memory, wherein said records each contain a plurality of search engine query-searchable fields relating to features of a real estate property;
ii) a communication port suitable for transmitting and receiving data and instructions in the form of electrical signals, to and from remote computers;
iii) a database manager for creating user accounts and creating, modifying, and deleting entries present in said database, said database manager being connected to said computer-readable memory responsive to a plurality of said remote computers;
iv) a database query engine operatively connected to said memory, said engine configured to permit a features-based search of said plurality of computer-readable records by system users;
v) a process controller operatively connected to at least one of said database manager and said search engine; and
vi) a recorder for logging the activity of each of said system users within said system,
said system being programmed to:
A) receive and store system registration information from each person of a buyer, a seller, and an agent in system memory;
B) receive and store descriptive information concerning items of commerce offered for sale by said provider in system memory;
C) provide information concerning items offered for sale by said provider to any member of the general public, including buyers, who access said system;
D) query a buyer who accesses said system to determine whether the buyer desires to be represented by an agent in a future transaction involving a provider's offering;
E) receive a reply from said buyer indicating either identification of an agent already selected by buyer, or a request from buyer that the system assist buyer in their becoming associated with an agent;
F) associate an agent with said buyer;
G) provide an indication to said buyer that an agent has been associated with said buyer in the system;
H) receive and recording an approval from said buyer of representation by said agent;
I) provide notification to said agent that said buyer has accepted representation of said agent;
J) receive and record acceptance of said agent to representation of said buyer;
K) notify said buyer that agent has accepted representation of said buyer;
L) increase the amount of information available to said buyer from the system concerning items offered for sale by said provider to be more than was available to buyer prior to step (I) above;
M) record the activity of said buyer within said system;
N) optionally provide the recorded viewing activity of said buyer in M) to said agent;
O) record the activity of said agent within the system;
P) optionally provide a report of the activity of at least one of said buyer and said agent within said system to said provider;
Q) transmit a request message to said provider, requesting the provider to approve the registration of said buyer with respect to items offered by that particular provider over any selected geographical range, the existence and contents of said request message being recorded and stored in computer-readable memory;
R) transmit an approval message from said provider to either or both of said agent or buyer of said registration of said buyer with respect to items offered by that provider over said selected geographical range, the existence and contents of said approval message being recorded and stored in system memory;
S) Notify said buyer of acceptance by said provider of said buyer and agent's representation thereof.

13) A method according to claim 12 wherein the agent associated with said buyer at the step of associating an agent with said buyer is one of: an agent indicated by buyer as having already been selected by buyer; an agent selected by buyer from a plurality of agents identified by said system to said buyer; and an agent assigned to buyer by said system.

14) A method according to claim 12 wherein the buyer, agent, and provider physically meet one another at any selected point in time after the pre-registration completed at step L).

15) A method according to claim 12 wherein associating an agent with said buyer within said system is conducted by said agent, said buyer being an already-existing client of said agent.

16) A method according to claim 12 wherein said system provides legal terms and conditions that must be agreed to by said user prior to the system accepting an approval from said buyer of representation by an agent.

17) A method according to claim 12 wherein said system denies access normally afforded to professionally-licensed agents who provide their system registration information to persons not possessing a professional license required for transactions involving the subject items of commerce in the applicable jurisdiction.

18) A method according to claim 12 wherein said providing information concerning items offered for sale by said provider to any member of the general public who access said system is undertaken via a hyperlink present on an agent's own website, which is a link that directs one to a portal of the system.

19) A method according to claim 12, said computer system further performing the step of: U) receiving a request from said agent for system to create a private label website for said agent to be used in conjunction with agent's own website.

20) A method according to claim 19 wherein said system further performs the step of providing a private label website for said agent, responsive to the system's receiving and recording a request from said agent for said system to create such private label website.

21) A method according to claim 12 wherein a notification is transmitted to other agents who may have attempted or may later attempt to submit that same potential buyer to the system, informing such other agents that the subject potential buyer has already been presented and is in a working relationship with a first agent.
